(19) United States
(12) Patent Application Publication
(10) Pub. No.: US 2026/0175932 A1
(43) Pub. Date: Jun. 25, 2026

(54) Method for Producing an Assembly for a Motor Vehicle and Assembly

(71) Applicant: Bayerische Motoren Werke Aktiengesellschaft, Muenchen (DE)

(72) Inventors: Konstantin Firlus, Garching (DE); Stefan Leinweber, Herrsching am Ammersee (DE)

(21) Appl. No.: 19/424,313

(22) Filed: Dec. 18, 2025

(30) Foreign Application Priority Data
Dec. 19, 2024 (DE) 10 2024 138 943.5

(51) Int. Cl. B62D 65/02; B21D 39/02; B62D 27/02

(52) U.S. Cl. CPC B62D 65/02; B21D 39/021; B62D 27/026

(57) ABSTRACT

A method for producing an assembly for a motor vehicle includes providing two separately formed components; applying adhesive intended for adhesively bonding the components to one another on at least one of the components; connecting the components by crimping; performing an immersion bath treatment of the connected components by electrophoretic deposition, by which the components are coated, where a gap extending between the adhesive and at least one of the components is formed during the crimping on a surface of the adhesive, which gap is filled at least partially with coating material by which the coating of the components is carried out during the immersion bath treatment, in which a coating of the components is formed.

### CROSS REFERENCE TO RELATED APPLICATION

This application claims priority under 35 U.S.C. § 119 from German Patent Application No. DE 10 2024 138 943.5, filed Dec. 19, 2024, the entire disclosure of which is herein expressly incorporated by reference.

### BACKGROUND AND SUMMARY

The invention relates to a method for producing an assembly for a motor vehicle. Furthermore, the invention relates to an assembly for a motor vehicle.

WO 02/094 639 A1 discloses a method for producing a structural component for a motor vehicle, in particular an elongated carrier component, which is composed of at least two partial shells which are connected to one another along flanges, wherein the partial shells of the structural component are connected to one another by crimping and, before crimping, an adhesive is applied to at least one flange, which is high-strength after curing.

The object of the invention is to provide a method for producing an assembly for a motor vehicle and an assembly for a motor vehicle, so that a production effort of the assembly can be kept particularly low.

A first aspect of the invention relates to a method for producing an assembly for a motor vehicle, in particular for a side door of the motor vehicle or for a body of the motor vehicle. The motor vehicle is designed, for example, as an automobile, in particular a passenger vehicle. Preferably, the motor vehicle, in particular in its completely produced state, comprises the assembly. The assembly can be understood in particular as an assembly unit.

At least the following steps are carried out in the method:
providing two separately formed components;
applying adhesive intended to adhesively bond the components to one another to at least one of the components;
connecting the components by means of crimping; and
performing at least one immersion bath treatment of the mutually connected components by means of electrophoretic deposition, by which the components are coated.

This may be understood in particular to mean the following: The adhesive, which is intended to adhesively bond the components to one another, is applied, in particular directly, to at least one of the components. In other words, a, in particular direct, adhesive application takes place on at least one of the components, in particular to adhesively bond components to one another, for example, directly, at a later time. The components are connected to one another, in particular directly, by means of crimping, in particular subsequently. This means that by means of crimping at least one formfitting connection is formed, by means of which the components are or will be connected to one another. In other words, the components are connected at least by means of crimping. The application of the adhesive is preferably carried out before the components are connected by means of crimping, i.e., before crimping. The adhesive is preferably provided for additional fixing of the components with respect to the crimping. During the crimping, the components are preferably adhesively bonded by means of the adhesive, which is in particular applied to the at least one component. This means that the adhesive bonding of the components by means of the adhesive preferably accompanies the crimping. The adhesive is, for example, crimp adhesive. Furthermore, an immersion bath treatment of the components which are connected to one another, in particular by means of crimping, is carried out by means of electrophoretic deposition, by which the components are coated. In the immersion bath treatment, the components are preferably submerged or immersed in at least one immersion bath medium. For example, an immersion bath tub is at least partially filled with the immersion bath medium. Electrophoretic deposition, which is carried out in particular in the context of immersion bath treatment, is, for example, a cathodic dip coating (CDC). The components are coated at least in some areas, in particular predominantly or completely, i.e., provided with at least one, in particular respective coating, by the electrophoretic deposition, i.e., by carrying out the electrophoretic deposition or the immersion bath treatment. This means that coating material is applied to the components, in particular applied, in order to coat the components, i.e., to form the above-mentioned, in particular respective coating. The coating is thus formed in particular by the coating material.

The components are intended for the side door or the body, for example. Thus, the components are designed, for example, as door parts of the side door or as body components. For example, the components are formed as sheet metal parts. Thus, the components are made, for example, of metal, in particular of respective sheet metal.

In order to be able to produce the assembly particularly efficiently or with little effort, it is provided according to the invention that at least one gap extending, in particular directly, between the adhesive and at least one of the components, is formed during the crimping on, in particular in, at least one surface of the adhesive. This means that the adhesive is acted upon, in particular mechanically, during the crimping, by which the gap located on, in particular in, the adhesive is formed. In other words, the, in particular liquid, adhesive is formed or deformed during the crimping, so that the gap is formed on or in the adhesive. This means that the gap mentioned is formed, in particular in the adhesive, during the crimping. The gap is thus in particular a, preferably local, cavity formed in the adhesive, which extends between at least one of the components and the adhesive. The gap can also be understood as a recess. The gap is formed, for example, as a depression, in particular in the surface. The gap is filled at least partially, in particular predominantly or completely, with the coating material by means of which the components are coated during the immersion bath treatment or the electrophoretic deposition. This means that the gap is filled with the same coating material by means of which the coating of the components is also formed. In other words, during the immersion bath treatment, the gap is filled at least partially with the coating, i.e., closed by the coating or the coating material. In still other words, the coating or the coating material is arranged, in particular deposited, in the gap.

The invention is based in particular on the following findings and considerations: In the area of a vehicle side of the motor vehicle, in particular in the area of the side door, for example, in contrast to other attachments or a wheel house, particularly little installation space is available for such strack-following crimps, since, for example, strips have to be installed for sealing the side door. Furthermore, for example, corrosion protection has to be achieved for an exposed, in particular weather-affected, sheet-metal cut edge. Conventionally, corrosion protection for sheet steel doors, for example, is implemented by applying PVC (polyvinyl chloride) in the area of a trimmed edge of an outer sheet. However, the applied PVC typically requires too much installation space, for example, so that it is in particular not possible to install sealing strips or other components in the immediate vicinity. However, a combination of measures can make it possible to eliminate PVC, but a specific problem can arise, which is to be documented in particular with measures. This problem is, for example, a gap, also referred to as a CDC gap, between the adhesive, in particular the adhesive that has overflowed, and at least one of the components, i.e., in particular, a sheet metal plate.

The above-mentioned disadvantages can be overcome by means of the method according to the invention. Thus, by means of the method according to the invention, a crimped connection having a seal caused by the adhesive can be implemented. By forming the gap during the crimping and at least partially filling the gap with the coating material, a tight, in particular liquid-tight, connection between the adhesive and the at least one of the components can be created. This means that the adhesive is or will be formed as a sealing element, which in particular seals the at least one component. In particular, during the immersion bath treatment, the coating material flows into the, in particular liquid, adhesive into the gap formed, due to which a clean sealing surface results. This means that the coating material can accumulate in a niche in the form of the gap mentioned to form the sealing surface. Thus, the above-mentioned CDC gap can be closed, by which the components, i.e., in particular a sheet metal plate lying under the adhesive, i.e., at least one of the components, can be protected from corrosion. The protection against corrosion can take place particularly efficiently, since the seal can be formed by the adhesive. The assembly can thus be produced particularly efficiently. The gap to be filled with the coating material can be formed particularly efficiently and/or precisely by the crimping. Overall, it can be seen that corrosion protection for the assembly can be effectuated particularly efficiently manner by means of the method according to the invention.

In a further embodiment, it is provided that the gap is formed on or in an adhesive area of the adhesive, the adhesive area of which is arranged on at least one, in particular axial, end area of a wraparound of the at least one of the components formed by the crimping. This means that the gap is arranged at the, in particular axial, end area of the wraparound of the at least one of the components formed by the crimping. This allows corrosion protection to be particularly improved in a particularly efficient way.

In further embodiment, it is provided that, when performing the immersion bath treatment, the adhesive is in a non-cured state. This means that during the immersion bath treatment, the adhesive is not cured, i.e., in particular is not expanded, and, for example, the adhesive is liquid. In other words, before performing the immersion bath treatment, the adhesive is not cured, in particular not expanded, for example by means of heat treatment. This means that before performing the immersion bath treatment, no heat is supplied to the adhesive in order to cure, in particular to expand, the adhesive. In still other words, the adhesive is not in a cured, in particular completely cured state during the immersion bath treatment. This embodiment is based in particular on the surprising finding that if the adhesive were already cured, in particular expanded, before the immersion bath treatment for example, the surface of the adhesive will become cracked, in particular particularly strongly, due to which, for example, a tight flange cannot be made possible. The seal caused by the adhesive can thus be improved in particular. This means that a sealing effect caused by the adhesive can particularly be improved. The corrosion protection can therefore be particularly enhanced, in particular particularly efficiently.

In further embodiment, it is provided that before the immersion bath treatment, a heat treatment, in particular for curing the adhesive, is omitted, i.e., not carried out. This means that the adhesive is not exposed to heat before the immersion bath treatment, which means that the adhesive is in particular not cured before the immersion bath treatment. This ensures that the adhesive is in the non-cured state during the immersion bath treatment, which can particularly improve the sealing effect.

In a further embodiment, it is provided that the connection of the components by means of crimping, i.e., the above-mentioned crimping, is carried out or performed by means of at least one crimping tool. In other words, for connecting the components by means of crimping, at least one of the components is acted upon, in particular directly, by means of the crimping tool or using the crimping tool, in particular mechanically. This action, for example, causes the formation of the gap. By acting upon the at least one of the components by means of the crimping tool, for example, the adhesive is acted upon at least indirectly, for example, with mediation of at least one of the components, by the crimping tool, by which the adhesive is squeezed out, for example, from at least one of the components, which can be referred to as adhesive discharge. The gap can thus be formed.

The crimping tool preferably has at least one helical application surface, by means of which at least one of the components is acted upon, in particular directly, to crimp the components, i.e., to connect the components by means of crimping. In other words, the components are crimped at least by means of the helical application surface of the crimping tool. The application surface can be understood in particular as a tool action surface of the crimping tool. The feature “helical” can be understood in particular as helical, screw-shaped, and/or spiral. The crimping can thus also be referred to as helical crimping. Thus, the application surface in particular has a helical, spiral, helical, or screw-shaped form. The helical shape, for example, enables crimping in ultrasmall spaces, wherein a particularly clean crimping edge, in particular sheet metal edge, can be formed. Furthermore, a particularly defined adhesive edge of the adhesive can be formed during the crimping. This means that the adhesive, applied in particular before crimping, can be brought into a desired position, and in particular it can be ensured that the adhesive has a desired thickness after crimping. In this way the components can be adhesively bonded to one another, in particular deliberately, during the crimping. Furthermore, the geometry and/or thickness of the adhesive can be deliberately adjusted. Furthermore, the above-mentioned gap can be deliberately formed by the helical shape. The helix crimping joining technique can thus enable the forming of the gap.

In a further embodiment, it is provided that the adhesive is free of cavities after crimping. In other words, the adhesive can be kept free of the cavities. This means that the adhesive has no cavities. This means, for example, that it is crimped in such a way that no cavities are formed. This can prevent the immersion medium or coating material from flowing into the cavities mentioned during the immersion bath treatment. This enables a particularly precise sealing effect to be achieved by means of the adhesive. Keeping the adhesive free from the cavities is achieved, for example, by the helical shape of the crimping tool, by which the, in particular liquid, adhesive can be formed particularly precisely and/or cleanly.

In a further embodiment, it is provided that the components are mechanically locked with one another, in particular in a friction-locked and/or formfitting manner, in addition to the connection by means of crimping before the immersion bath treatment, in particular during the crimping. In other words, the components are mechanically fixed relative to one another, so that, for example, relative movements, which the connection by means of crimping would allow between the components, are preventable or prevented. The components can thus be fixed in a defined attitude or orientation relative to one another, in particular held on one another fixed relative to one another, and in particular although the adhesive is in the non-cured state before the immersion bath treatment. This is because if the adhesive is not cured, for example, a relative movement is possible between the components in spite of the connection by means of crimping. However, this relative movement can be avoided particularly securely by means of the mechanical locking. It can thus be ensured that, for example, during transport and/or during the immersion bath treatment, the components do not move relative to one another, in particular unintentionally. A manufacturing quality of the assembly can thus particularly be increased. This can be done particularly efficiently, because for example, no separate fixing measures are necessary to hold the components fixed on one another before the immersion bath treatment or during the immersion bath treatment. The production effort of the assembly can thus be kept particularly low.

For example, the components have a respective surface structure at least in some areas. This means that the first component has a first surface structure at least in some areas and that the second component has a second surface structure, in particular different from the first surface structure, at least in some areas. The respective surface structure can be understood in particular as a respective structuring of at least one respective surface of the respective component. Preferably, during the crimping of the components, i.e., during the connection of the components by means of crimping, the components are connected to one another in a formfitting manner, in particular directly, in particular to form the mechanical locking, by means of the respective surface structure, i.e., by means of the first and the second surface structure. This means that the components are connected to one another in a formfitting manner via the surface structures during the crimping, in particular by engaging the surface structures with one another, in particular directly. The mechanical locking of the components can thus be effectuated by the surface structure, wherein this locking in particular takes place in a formfitting and/or friction-locked manner.

For example, it is provided that at least the surface structure of one of the components has a toothing, which is engaged with the surface structure of the other of the components during the crimping of the components in order to connect the components to one another in a formfitting manner. This means that the components, in particular in addition to the crimping, are connected to one another in a formfitting manner via the toothing of the at least one surface structure by means of the at least one toothing. In other words, the formfitting connection of the components takes place in that the surface structures are or become engaged with one another. The components can thus be fixed particularly well relative to one another, by which the transport and/or the immersion bath treatment can be carried out particularly securely. Preferably, the respective surface structure has such a toothing in each case, wherein the toothings in particular are or become engaged with one another. For example, the components are or will be laser-treated to form the surface structures, in particular the at least one toothing. The toothing or the respective toothing can thus be formed as laser toothing.

In a further embodiment, it is provided that at least one edge of at least one of the components is rounded or filleted before the immersion bath treatment, and in particular before the crimping. In other words, before the immersion bath treatment, in particular before the crimping, at least one edge fillet is carried out or formed on the at least one component. Edge thinning can thus be avoided or kept particularly low. In particular, swirling of the adhesive during the adhesive discharge can be kept particularly low or avoided. The rounding or filleting of the edge is carried out, for example, by means of at least one laser. The edge fillet can therefore be a laser edge fillet.

Preferably, it is provided that the rounding of the at least one edge is carried out before the crimping. This means that the edge is already rounded before the crimping. This embodiment is based in particular on the recognition that prior to crimping, an accessibility to the components for rounding the edge is particularly good, due to which the edge can be rounded particularly efficiently and/or particularly precisely.

A second aspect of the invention relates to an assembly for a motor vehicle, in particular for a side door of the motor vehicle and/or for a body, for example a passenger cell, of the motor vehicle. Preferably, the assembly is or will be produced according to a method according to the first aspect of the invention or by means of the method according to the first aspect of the invention. Advantages and advantageous refinements of the first aspect of the invention can be considered to be advantages and advantageous refinements of the second aspect of the invention, and vice versa.

The assembly has at least two components formed separately from one another and connected to one another by means of crimping, in particular directly, which are adhesively bonded to one another by means of adhesive, for example, directly, in particular additionally to the crimping, and are thus in particular fixed relative to one another. The components are thus designed, for example, as door parts of the side door or as body components of the body. The components are coated by means of electrophoretic deposition by means of an immersion bath treatment, in particular carried out after the crimping, i.e., provided by means of at least one respective paint, for example.

To be able to produce the assembly particularly efficiently, and in particular to enable sealing of the assembly particularly efficiently, the assembly has at least one gap that is formed during the crimping or by the crimping, in particular directly, on or in a surface of the adhesive and extends between the adhesive and at least one of the components, which is filled at least partially, in particular predominantly or completely, with coating material or the immersion bath medium by the immersion bath treatment, i.e., as a result of the immersion bath treatment. The coating material forms the coating. This means that the coating material, which fills the gap at least partially, and the coating material, which forms the coating of the components, is the same coating material. This coating material can also be referred to as a cathodic dip coating (CDC) medium.

Further advantages, features, and details of the invention can be found in the following description of a preferred exemplary embodiment as well as in the drawings. The features and combinations of features mentioned above in the description, and the features and combinations of features mentioned below in the description of the figures and/or shown in the figures alone are usable not only in the respectively specified combination but also in other combinations or alone.

The invention will now be explained in more detail on the basis of a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic partial sectional view of an assembly according to the invention;

FIG. 2 shows a schematic detailed view of an assembly according to the invention; and

FIG. 3 shows a schematic illustration to illustrate method steps of a method according to the invention.

### DETAILED DESCRIPTION OF THE DRAWINGS

In the figures, identical or functionally identical elements are provided with the same reference signs.

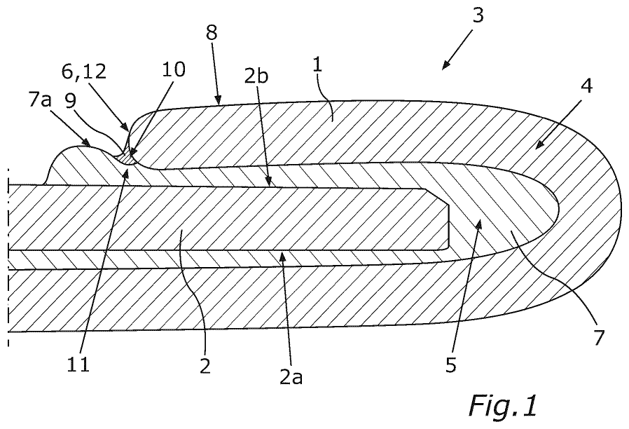

FIG. 1 shows a schematic partial sectional view of an assembly 3 for a motor vehicle. The assembly 3 is intended, for example, for a side door of the motor vehicle or for a body, in particular for a passenger cell, of the motor vehicle. Thus, the side door and/or body can comprise the assembly 3.

The assembly 3 has two separately formed components 1, 2. The component 1 can be referred to as the first component 1. The component 2 can be referred to as the second component 2. For example, the first component 1 is formed as a sheet metal component. For example, the second component 2 is formed as a sheet metal component. Thus, the respective component 1, 2 can be formed from sheet metal in each case. The respective component 1, 2, for example, is made of aluminum, in particular an aluminum alloy, or of steel. Thus, the above-mentioned sheet metal can be in particular an aluminum sheet and/or a steel sheet.

As illustrated in FIG. 1, the components 1, 2 are connected to one another by means of crimping, in particular directly. Thus, for example, one of the components 1, 2, in particular the first component 1, has at least one wraparound 4 formed by crimping, which surrounds the other of the components 1, 2, in the present case the second component 2, at least in some areas, by which in particular a form fit is or will be formed between the components 1, 2. The wraparound 4 forms a receptacle space 5 in the present case, in which the second component 2 is accommodated or arranged at least in some areas. Due to the formation of the wraparound 4, the first component 1 extends in the present case from a first side 2a of the second component 2 around the second component 2 to a second side 2b of the second component 2 facing away from the first side 2a. In the present case, the sides 2a, 2b are sides 2a, 2b opposite to one another of the second component 2.

Furthermore, the components 1, 2 are adhesively bonded to one another by means of adhesive 7, in particular directly, i.e., connected to one another by means of adhesive bonding. In the exemplary embodiment, the adhesive 7 extends on the first and second sides 2a, 2b, by which in the present case the components 1, 2 are adhesively bonded to one another by means of the adhesive 7 on both the first and the second side 2a, 2b. The adhesive 7 thus extends at least partially between the components 1, 2, in this case both on the first and the second side 2a, 2b. In the present case, the adhesive 7 is arranged or accommodated in the receptacle space 5. This means that the receptacle space 5 is filled at least in some areas with the adhesive 7, in particular to adhesively bond the components 1, 2 to one another.

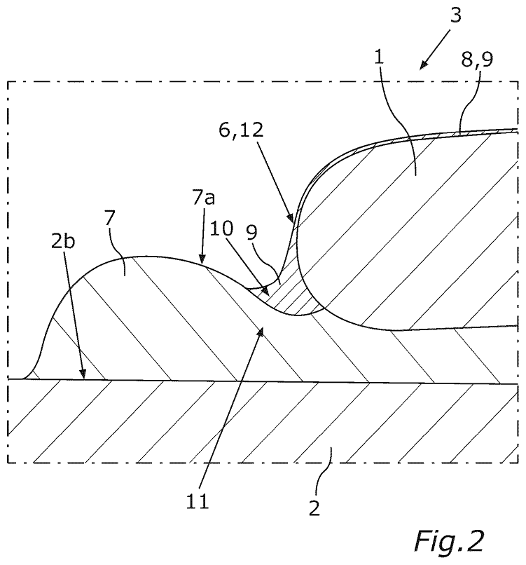

The components 1, 2 are or will be coated by at least one immersion bath treatment by means of electrophoretic deposition. This means that in the immersion bath treatment, the components 1, 2 are provided with at least one coating 8, i.e., coated by means of the electrophoretic deposition. The coating 8 can be seen particularly well in FIG. 2, in which the assembly 3 is shown in a schematic sectional view as a detailed view. In FIG. 2, a portion shown in FIG. 1 is shown in detail. Thus, in particular, the respective component 1, 2 has a respective coating 8. The, in particular respective, coating 8 is formed in the present case by coating material 9, which is applied, in particular deposited on the components 1, 2, in particular on a respective surface of the respective component 1, 2, in the immersion bath treatment or the electrophoretic deposition.

To be able to produce the assembly 3 particularly efficiently, in particular to be able to seal the assembly 3 particularly efficiently, the assembly 3 has at least one gap 10 formed on or in the adhesive 7, in particular a surface 7a of the adhesive 7 and extending between the adhesive 7 and at least one of the components 1, 2, for example, the first component 2. The gap 10 is formed during crimping, in particular by crimping. This is done, for example, by mechanically acting on the adhesive during crimping, for example by means of a crimping tool. Furthermore, the formed or shaped gap 10 is filled by the immersion bath treatment at least partially, in particular predominantly or completely, with the coating material 9, which, as already explained, forms the coating 8. Accordingly, filling the gap 10 is effectuated in particular by the immersion bath treatment. By forming the gap 10, and in particular by filling the gap 10 with the coating material 9, a sealing element that presses against the components 1, 2 and thus in particular seals the components 1, 2 can be or will be formed by the adhesive 7. By filling the gap 10 with the coating material 9, furthermore a distance present between the adhesive 7 and the at least one of the components 1, 2, in the present case the second component 2, can be closed. Thus, a particularly good sealing effect of the adhesive 7 can be achieved, due to which separate sealing elements or PVC can be dispensed with. Furthermore, corrosion protection of the assembly 3 can be particularly improved. As a result, a resistance of the assembly 3 can be particularly increased.

In the exemplary embodiment, the gap 10 is formed as a depression in the adhesive 7, in particular in the surface 7a. Thus, the gap 10 in the present case extends at least in some areas in the adhesive 7. In particular, the gap 10 is bounded at least in some areas by the adhesive 7 and/or by the at least one of the components 1, 2, in the present case by the first component 1. Preferably, an extension direction, in particular the main extension direction of the gap 10 runs at least substantially parallel to a bending axis, around which the wraparound 4 is or will be formed during the crimping. This means that, in particular during crimping, one of the components 1, 2, in the present case, the first component 1 is bent around the bending axis to form the wraparound 4, and in particular to connect the components 1, 2 by means of crimping. A depth direction of the depression extends, for example, obliquely or perpendicularly to the above-mentioned extension direction, in particular the main extension direction.

As can be seen particularly well in FIG. 1 and FIG. 2, in the exemplary embodiment the gap 10 is formed on or in an adhesive area 11 of the adhesive 7, the adhesive area 11 of which is arranged at an, in particular axial, end area 12 of the wraparound 4 formed by the crimping by means of one of the components 1, 2, in the present case of the first component 1. The end area 12 thus has at least one edge 6, which bounds or forms the respective 1, 2, in the present case the first component 1, in the axial direction, i.e., in the longitudinal extension direction, of the respective component 1, 2, in the present case of the first component 1, to the outside. The end area 12 can thus be understood in particular as an axial end. For example, the end area 12 is a flange area, in particular a flange, of the first component 1, in particular of the wraparound 4. As can be seen particularly well in FIG. 2, the gap 10, for example, is in the present case at least partially covered by the first component 1, in particular its axial end area 12, wherein the gap 10 extends beyond the axial end, in particular in the axial direction of the first component 1. Thus, for example, at least a partial area of the gap 10 in the axial direction of the first component 1 is adjacent to the axial end. The axial direction can be understood in particular as a longitudinal extension direction of the first component 1, which preferably runs obliquely or perpendicularly to the thickness direction of the component 2. The longitudinal extension direction preferably runs obliquely or perpendicularly to the bending axis. The axial end can thus be understood in particular as an end of the respective component 1, 2 with respect to its longitudinal extension direction.

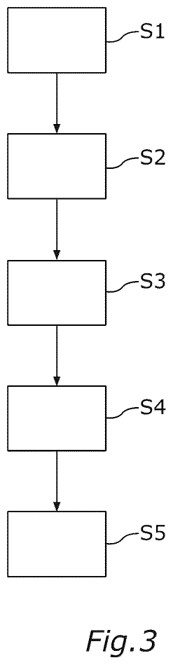

In FIG. 3, a method diagram of a method for producing the assembly 3 is illustrated. The assembly 3 therefore is or will be produced, for example, by means of the method.

In the method, at least steps S1, S2, S3, S4 are performed in the present case. During a first of the steps S1, the components 1, 2 are provided. During a second of the steps S2, in particular carried out after first step S1, the adhesive 7 intended to adhesively bond the components 1, 2 to one another is applied, in particular directly, to at least one of the components 1, 2, i.e., in particular to the first component 1. In a third of the steps S3, carried out in particular after second step S2, the components 1, 2 are connected to one another, in particular directly, by means of crimping. Thus, in particular during step S3, the above-mentioned wraparound 4 is formed. The adhesive bonding of the components 1, 2 by means of the adhesive 7 is carried out, for example, during the crimping, wherein after the crimping, in particular the adhesive 7 is not yet cured, i.e., is in a non-cured state. Thus, during crimping, at least partial areas of the components 1, 2 are brought together, for example, in such a way that in these partial areas the components 1, 2 are pressed together with the, in particular liquid, adhesive 7 interposed, and thus, for example, are adhesively bonded. In a fourth of the steps S4, carried out in particular after third step S3, the immersion bath treatment of the mutually connected components 1, 2 is carried out by means of electrophoretic deposition, by which the components 1, 2 are coated, i.e., provided with the coating 8. Electrophoretic deposition is, for example, a cathodic dip coating (CDC). The immersion bath medium and/or the coating material 9 can thus be referred to as a CDC medium.

To be able to produce the assembly 3 particularly efficiently and in particular to be able to seal the assembly 3 particularly efficiently, the gap 10 extending between the adhesive 7 and the at least one of the components 1, 2 is formed during the crimping on the surface 7a of the adhesive 7, which gap is filled at least partially with the coating material 9 during the immersion bath treatment, by means of which the coating of the components 1, 2 is carried out or has been carried out previously. During the coating, in particular the coating 8 is formed.

For example, the adhesive 7 is in the non-cured state when the immersion bath treatment is carried out. This means that while the immersion bath treatment is carried out, the adhesive 7 is in the non-cured state. In other words, the immersion bath treatment is carried out without, in particular prior, curing, in particular expanding, of the adhesive 7. Thus, during the immersion bath treatment, for example, a composite formed from the components 1, 2 is placed in a CDC bath without adhesive curing, i.e., in particular without the adhesive 7 previously having been cured. Thus, the adhesive 7 is in particular liquid, and in particular non-expanded, adhesive 7 during the immersion bath treatment. The adhesive 7 is thus in particular free of cured adhesive during the immersion bath treatment, i.e., in particular free of cured partial areas. In other words, the adhesive 7 is in a liquid, in particular viscous, physical state during the immersion bath treatment.

As can be seen particularly well in FIG. 1 and FIG. 2, for example, the gap 10 is formed on the adhesive area 11 of the adhesive 7, the adhesive area 11 of which is arranged at the end area 12 of the wraparound 4, formed by the crimping, of the at least one of the components 1, 2.

Preferably, before the immersion bath treatment, i.e., in particular before the formation of the gap 10, a, in particular active, heat treatment of the adhesive 7 is omitted. This means that before the immersion bath treatment, the adhesive 7 is not subjected to heat, due to which the adhesive 7 in particular will not be or is not cured by means of the heat before the immersion bath treatment is carried out.

Preferably, before the immersion bath treatment, at least the edge 6 of at least one of the components 1, 2, in the present case of the first component 1, is rounded, for example, by means of at least one laser tool. The rounding of the edge 6 is preferably carried out before the crimping. Alternatively or additionally, for example, further edges of the first and/or the second component 1, 2 are rounded, in particular before the immersion bath treatment, preferably before crimping. Edge thinning can be kept particularly low or avoided by rounding the edge 6 or the further edges.

For example, the adhesive 7 is cured during the immersion bath treatment. Alternatively or additionally, the adhesive 7 is dried after the immersion bath treatment, i.e., for example, in a fifth step S5, which is not shown in FIG. 3 and takes place after fourth step S4, for example by means of at least one drying device, by which the adhesive 7, for example, is cured, and in particular expanded. The drying device is provided, for example, for drying the coating 8. Thus, the drying of the coating 8 and the curing of the adhesive 7 can be done by means of the same drying device. The curing, and in particular the expansion, of the adhesive 7 can thus be carried out, for example, after a CDC bath, in a dryer also referred to as a CDC dryer. During the drying, the adhesive 7 is subjected, for example, in particular actively with heat provided, in particular by the drying device, to dry the adhesive 7.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

1 first component
2 second component
2a first side of the second component
2b second side of the second component
3 assembly
4 wraparound
5 receptacle space
6 edge
7 adhesive
7a surface
8 coating
9 coating material
10 gap
11 adhesive area
12 end area
S1 first step
S2 second step
S3 third step
S4 fourth step
S5 fifth step

What is claimed is:

1. A method for producing an assembly for a motor vehicle, comprising the steps of:
providing a first component and a second component, wherein the first component and the second component are separately formed;
applying an adhesive to at least one of the first component and the second component;
connecting the first component and the second component by crimping;
performing an immersion bath treatment of the connected first component and the second component by electrophoretic deposition; and
during the crimping, forming a gap extending between the adhesive and at least one of the first component and the second component on a surface of the adhesive and filling the gap at least partially during the immersion bath treatment with a coating material via which the first component and the second component are coated.

2. The method according to claim 1, wherein the gap is formed on an adhesive area of the adhesive and wherein the adhesive area is disposed at an end area of a wraparound formed by crimping of one of the first component and the second component.

3. The method according to claim 1, wherein the adhesive is in an uncured state when performing the immersion bath treatment.

4. The method according to claim 3, wherein before performing the immersion bath treatment, heat treatment of the adhesive does not take place.

5. The method according to claim 1, wherein the crimping is performed by a crimping tool which has a helical application surface via which at least one of the first component and the second component is acted upon to perform the crimping.

6. The method according to claim 1, wherein the adhesive is free of cavities after the crimping.

7. The method according to claim 1, wherein the first component and the second component are mechanically locked with one another in addition to the crimping before the performing of the immersion bath treatment.

8. The method according to claim 1, further comprising the step of rounding an edge of at least one of the first component and the second component before the performing of the immersion bath treatment.

9. The method according to claim 8, wherein the rounding of the edge is performed before the crimping.

10. An assembly for a motor vehicle, comprising:
a first component and a second component, wherein the first component and the second component are formed separately from one another, wherein the first component and the second component are connected to one another by crimping, wherein the first component and the second component are adhesively bonded to one another by an adhesive, and wherein the first component and the second component are coated by an immersion bath treatment by electrophoretic deposition;
wherein a gap formed during the crimping and formed on a surface of the adhesive extending between the adhesive and one of the first component and the second component is filled by the immersion bath treatment at least partially with a coating material via which the first component and the second component are coated.
